(19) United States
(12) Patent Application Publication
(10) Pub. No.: US 2023/0018024 A1
(43) Pub. Date: Jan. 19, 2023

(54) THERMAL AND DIELECTRIC INSULATOR FOR BATTERY PACK

(71) Applicant: FEDERAL-MOGUL POWERTRAIN LLC, Southfield, MI (US)

(72) Inventors: Shozo Fukuyama, Tokyo (JP); Emi Itoh, Kanagawa-ken (JP)

(21) Appl. No.: 17/866,316

(22) Filed: Jul. 15, 2022

Related U.S. Application Data
(60) Provisional application No. 63/223,481, filed on Jul. 19, 2021.

(51) Int. Cl. H01M 10/658; H01M 10/625

(52) U.S. Cl. CPC H01M 10/658; H01M 10/625; H01M 2220/20

(57) ABSTRACT

A flexible thermal insulator for an electric vehicle battery pack, and an electric vehicle battery pack therewith is provided. The flexible thermal insulator has a composite wall including a sheet of fire-resistant material having opposite first and second sides. A first pressure sensitive adhesive layer is bonded to the first side of the sheet of fire-resistant material. Further, one of a scrim reinforced, polyether ether ketone layer is bonded to the second side of the fire-resistant material, or a silicone rubber layer is bonded to the second side of the fire-resistant material.

### CROSS-REFERENCE TO RELATED APPLICATION

This application claims the benefit of U.S. Provisional Application Ser. No. 63/223,481, filed Jul. 19, 2021, which is incorporated herein by reference in its entirety.

### BACKGROUND OF THE INVENTION

### 1. Technical Field

This invention relates generally to thermal and dielectric insulators, and more particularly to thermal and dielectric insulators for inhibiting flame propagation within and from a battery pack.

### 2. Related Art

It is known to contain or shield battery packs, including those used in electric vehicle applications, in thermal insulation. A common material used to form such thermal insulation is a fiberglass fabric. Although the fiberglass fabric insulation provides an acceptable level of protection against contamination and environmental temperatures during normal use, the fiberglass fabric insulation does not provide a desired level of protection against flame propagation outwardly from the battery pack or between cells of the battery pack, such as may be experienced in a thermal runaway condition of one or more cells of the electric vehicle battery pack. It is desired to provide a thermal insulation that also offers dielectric protection to the battery pack, while inhibiting the propagation of flame from the battery pack and between cells of the battery pack.

### SUMMARY OF THE INVENTION

It is an object of the present disclosure to provide a thermal insulator for use with an electric vehicle battery pack that addresses at least the desire to inhibit the propagation of flame from the battery pack and between cells of the battery pack.

It is a further object to inhibit the propagation of flame from the battery pack and between cells of the battery pack for 5 minutes at a temperature of 1000° C.

It is a further object to inhibit the propagation of flame from the battery pack and between cells of the battery pack for upwards to 10 minutes at a temperature of 1000° C.

It is a further object of the present disclosure to provide a thermal insulator for use with an electric vehicle battery pack that addresses at least the desire to provide dielectric protection to the battery pack and between cells of the battery pack.

It is a further object of the present disclosure to provide a thermal insulator for use with an electric vehicle battery pack that is flexible to facilitate conformability of the thermal insulator about the battery pack and between cells of the battery pack.

It is a further object of the present disclosure to facilitate the ease installation of a thermal insulator about the battery pack and between cells of the battery pack.

It is a further object of the present disclosure to provide a thermal insulator for an electric vehicle battery pack that is lightweight, that has a low profile to minimize the amount of space occupied by the thermal insulator, and that is economical in manufacture and in use.

One aspect of the invention provides a thermal insulator for an electric vehicle battery pack having a wall including a scrim reinforced, polyether ether ketone layer, a first pressure sensitive adhesive layer coated on a side of the scrim reinforced, polyether ether ketone layer, and a silica fabric bonded to the pressure sensitive adhesive.

In accordance with another aspect of the invention, a second pressure sensitive adhesive layer can be bonded on the silica fabric to facilitate fixing the thermal insulator in the desired location.

In accordance with another aspect of the invention, a release film can be releasably fixed to the second pressure sensitive adhesive layer, with the release film being configured to be removed to expose the underlying second pressure sensitive adhesive layer for fixation to a surface of electric vehicle battery pack and/or to a housing thereof.

In accordance with another aspect of the invention, the first pressure sensitive adhesive layer and the second pressure sensitive adhesive layer can be provided as an acrylic pressure sensitive adhesive.

In accordance with another aspect of the invention, the wall prevents flame propagation when exposed to 1000° C. for 10 minutes.

In accordance with another aspect of the invention, the wall has an electrical insulation resistance of 4000 Mohm or greater before and after being exposed to 1000° C. for 10 minutes.

In accordance with another aspect of the invention, the wall has a maximum thickness of 5 mm, thereby having a low profile to enhance design options and reduce weight.

In accordance with another aspect of the invention, the wall has a maximum thickness of 2 mm, thereby having a minimized profile to enhance design options and minimize weight.

In accordance with another aspect of the invention, the wall has a dielectric strength of 2 kV after being exposed to 1000° C. for 10 minutes.

In accordance with another aspect of the invention, a flexible thermal insulator for an electric vehicle battery pack has a composite wall including a sheet of silica fabric having opposite first and second sides, and a first pressure sensitive adhesive layer bonded to the first side of the sheet of silica fabric.

In accordance with another aspect of the invention, a flexible thermal insulator for an electric vehicle battery pack is provided having a composite wall including a sheet of flame-resistant material having opposite first and second sides. A first pressure sensitive adhesive layer is bonded to the first side of the sheet of flame-resistant material. Further, one of a scrim reinforced, polyether ether ketone layer is bonded to the second side of the flame-resistant material, or a silicone rubber layer is bonded to the second side of the flame-resistant material.

In accordance with another aspect of the invention, a second pressure sensitive adhesive layer can be bonded to the scrim reinforced, polyether ether ketone layer.

In accordance with another aspect of the invention, a release film can be releasably fixed to the first pressure sensitive adhesive layer, with the release film being configured to be removed to expose the underlying first pressure sensitive adhesive layer for fixation to a surface of electric vehicle battery pack and/or to a housing thereof.

In accordance with another aspect of the invention, the first pressure sensitive adhesive layer and the second pressure sensitive adhesive layer can be provided as an acrylic pressure sensitive adhesive.

In accordance with another aspect of the invention, the composite wall prevents flame propagation when exposed to 1000° C. for 10 minutes.

In accordance with another aspect of the invention, the composite wall has an electrical insulation resistance of 4000 Mohm or greater before and after being exposed to 1000° C. for 10 minutes.

In accordance with another aspect of the invention, the composite wall has a maximum thickness of 5 mm.

In accordance with another aspect of the invention, the composite wall has a maximum thickness of 2 mm.

In accordance with another aspect of the invention, the composite wall has a dielectric strength of 2 kV after being exposed to 1000° C. for 10 minutes.

In accordance with another aspect of the invention, the composite wall of the flexible thermal insulator includes a silicone layer bonded to the second side of the sheet of silica fabric.

In accordance with another aspect of the invention, an electric vehicle battery pack is provided. The electric vehicle battery pack includes a housing bounding a plurality of cells. Further, a composite wall overlies the plurality of cells. The composite wall includes: a sheet of silica fabric having opposite first and second sides and a first pressure sensitive adhesive layer bonded to the first side of the sheet of silica fabric.

In accordance with another aspect of the invention, the electric vehicle battery pack can further include a second pressure sensitive adhesive layer bonded to the scrim reinforced, polyether ether ketone layer.

In accordance with another aspect of the invention, the electric vehicle battery pack can further include a release film releasably fixed to the first pressure sensitive adhesive layer, with the release film being configured to be removed to expose the underlying first pressure sensitive adhesive layer for operable fixation to a surface of the housing.

In accordance with another aspect of the invention, the first pressure sensitive adhesive layer and the second pressure sensitive adhesive layer of the electric vehicle battery pack can be provided as an acrylic pressure sensitive adhesive.

In accordance with another aspect of the invention, the composite wall of the electric vehicle battery pack prevents flame propagation when exposed to 1000° C. for 10 minutes.

In accordance with another aspect of the invention, the composite wall of the electric vehicle battery pack has an electrical insulation resistance of 4000 Mohm or greater before and after being exposed to 1000° C. for 10 minutes.

In accordance with another aspect of the invention, the composite wall of the electric vehicle battery pack has a maximum thickness of 5 mm.

In accordance with another aspect of the invention, the composite wall of the electric vehicle battery pack has a maximum thickness of 2 mm.

In accordance with another aspect of the invention, the composite wall of the electric vehicle battery pack has a dielectric strength of 2 kV after being exposed to 1000° C. for 10 minutes.

In accordance with another aspect of the invention, the composite wall of the electric vehicle battery pack further includes a silicone layer bonded to the second side of the sheet of flame-resistant material, wherein the flame-resistant material is a silica fabric.

In accordance with another aspect of the invention, the silica fabric is woven from silica multifilament yarns.

### BRIEF DESCRIPTION OF THE DRAWINGS

These and other aspects, features and advantages will become readily apparent to those skilled in the art in view of the following detailed description of presently preferred embodiments and best mode, appended claims, and accompanying drawings, in which:

FIG. 1 is a schematic perspective view of an electric motor vehicle having a battery pack with a plurality of thermal insulators constructed in accordance with an aspect of the invention;

FIGS. 2A-2C illustrate a schematic representation of a plurality of cells in an electric vehicle battery pack, without thermal insulators in accordance with the invention, undergoing a thermal runaway condition with a flame propagating without hindrance from a location of flame initiation (FIG. 2A) throughout the battery pack (FIG. 2C);

FIGS. 3A-3C are views similar to FIGS. 2A-2C, with the battery pack including the plurality of thermal insulators, with the thermal insulators shown suppressing and inhibiting flame propagating from a location of a thermal runaway condition (FIG. 3A) throughout the battery pack (FIG. 3C);

FIG. 4 is a schematic perspective view of a thermal insulator in accordance with one embodiment of the disclosure;

FIG. 4A is a graph illustrating a housing surface temperature of a battery pack including the thermal insulator of FIG. 4, with the battery pack being exposed to 1000° C. for 10 minutes;

FIG. 5 is a schematic perspective view of a thermal insulator in accordance with another embodiment of the disclosure; and

FIG. 5A is a graph illustrating a housing surface temperature of a battery pack including the thermal insulator of FIG. 5, with the battery pack being exposed to 1000° C. for 10 minutes.

### DETAILED DESCRIPTION OF PREFERRED EMBODIMENTS

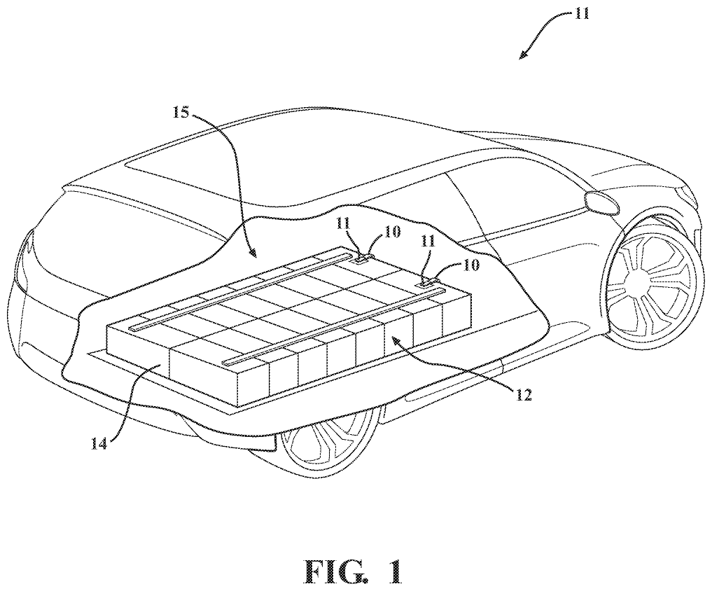

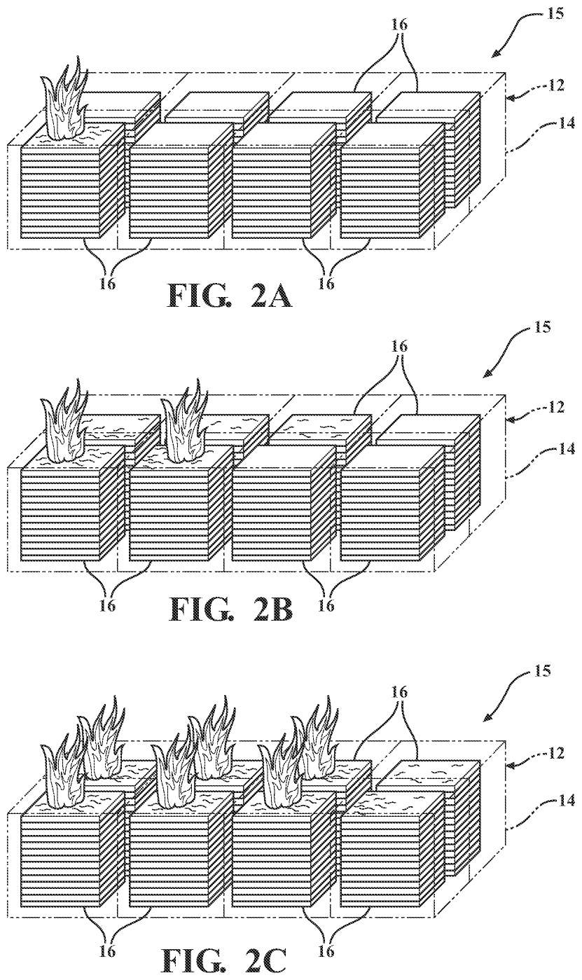

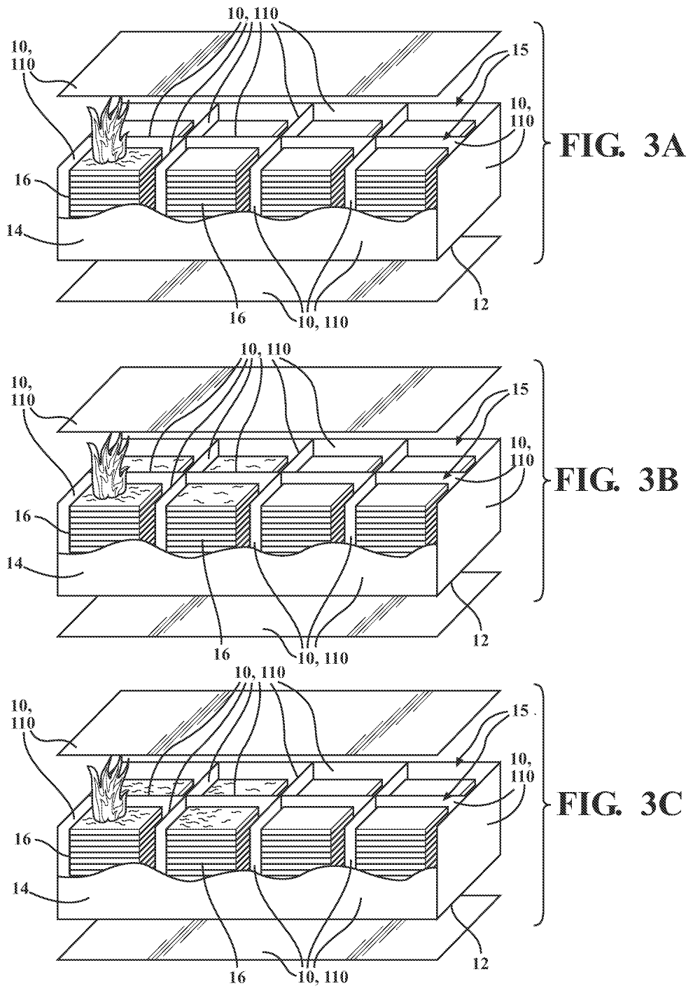

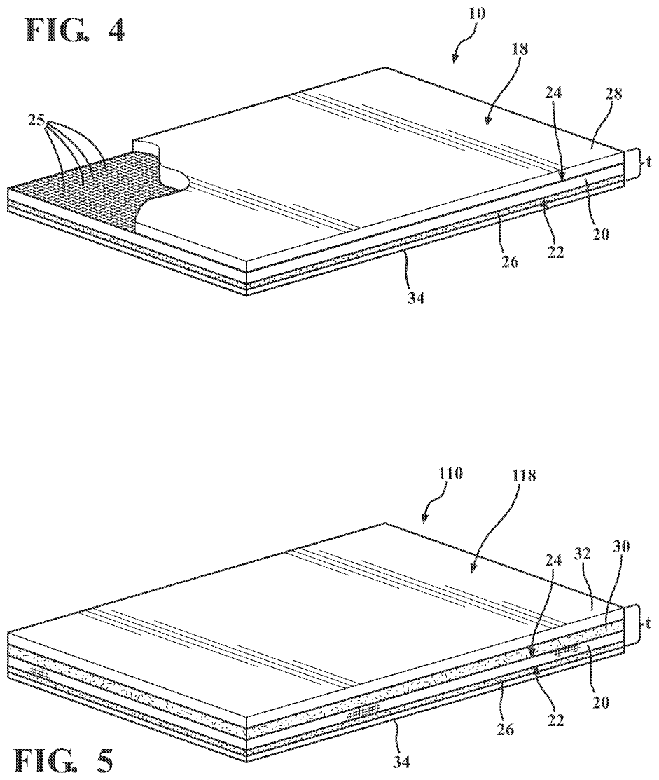

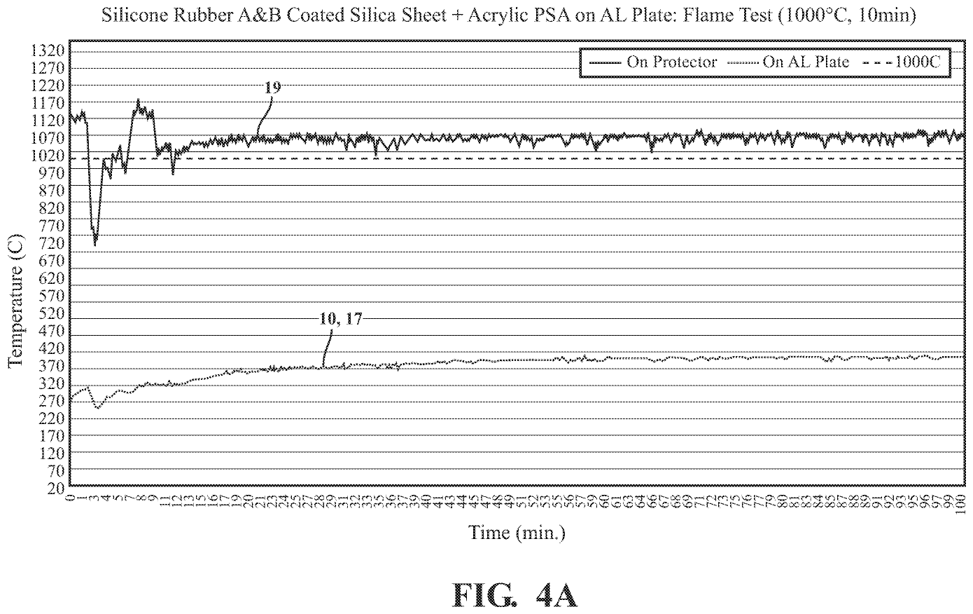

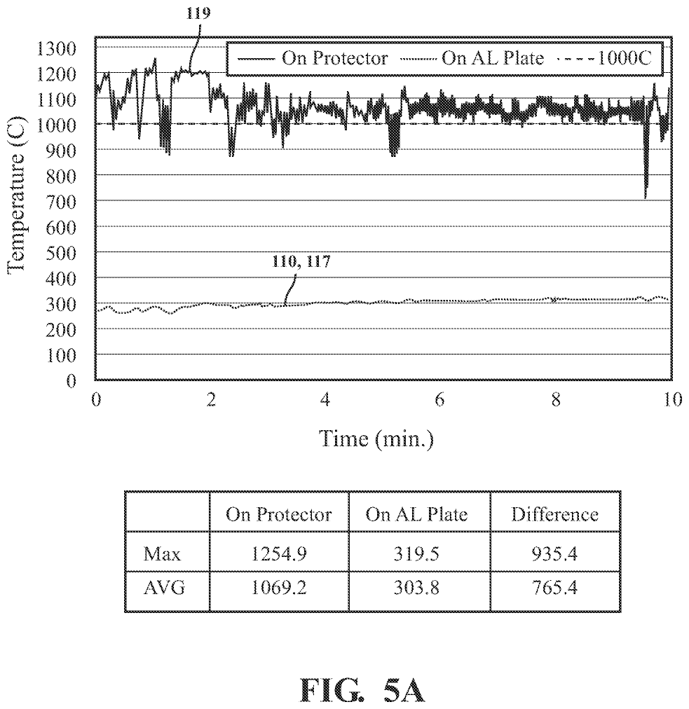

Referring in more detail to the drawings, FIG. 1 illustrates a motor vehicle, shown as an electrically powered motor vehicle, also referred to as electric vehicle 11, having a battery pack 12, such as a lithium-ion battery pack, configured with at least one, and shown as a plurality of thermal insulators 10 in accordance with an aspect of the invention. The electric vehicle battery pack 12 includes a housing 14 comprising a plurality of battery modules 15, with each battery module 15 bounding a plurality of cells 16. During normal use, and including in non-normal situations, such as in a vehicle crash condition or some other condition causing an impact force to battery pack 12, a thermal runaway condition originating in any one of the cells 16 is controlled and contained via the thermal insulator 10, such that flame propagation (spread) between cells 16 and outwardly from the battery pack 12 is prevented for at least 10 minutes, and an outer surface temperature of the battery housing 14, also referred to as case, is maintained to be less than 500° C., as evidenced in testing performed at a temperature of 1000° C. for 10 minutes (FIG. 4A illustrating the outer surface temperature 17 for a first embodiment of the thermal insulator 10 constructed in accordance with one aspect of the disclosure while exposed to a temperature indicated at 19 of 1000° C. for 10 minutes and FIG. 5A illustrating the outer surface temperature 117 for a second embodiment of a thermal insulator 110 constructed in accordance with another aspect of the disclosure while exposed to a temperature indicated at 119 of 1000° C. for 10 minutes, with the different thermal insulators 10, 100 being discussed in further detail below).

As shown schematically in FIG. 4, the thermal insulator 10 includes a generally planar composite sheet, also referred to as composite wall, laminated wall or wall 18, which overlies the plurality of the cells 16 and extends between the cells 16 to effectively insulate each cell 16 from an adjacent cell 16. The composite wall 18 includes a sheet of insulating fabric 20 having opposite first and second sides 22, 24. The insulating fabric 20 is formed of a flame-resistant material, such as a tightly woven flame-resistant filaments (also referred to as multifilament yarns), and in one preferred embodiment, insulating fabric 20 is formed entirely from tightly interlaced silica multifilament yarns 25, wherein the multifilament yarns 25 are preferably woven using a tight plain weave pattern for maximum density. Further, a first pressure sensitive adhesive layer 26 can be bonded to the first side 22 of the sheet of silica fabric 20 to facilitate fixation of the composite wall 18 to the desire surface of the battery pack 12, including between adjacent cells 16 and/or about an inner and/or outer surface of the housing 14. Further, a silicone rubber layer 28 is coated or otherwise bonded to the second side 24 of the sheet of silica fabric 20. The silicone rubber layer 28 is a fluid impervious layer, thereby enhancing protection against the ingress of contamination, while greatly enhancing the flame-resistant properties of the wall 18, thereby further inhibiting flame propagation outwardly from and between adjacent cells 16, thereby extending the useful life of the battery pack 12 during an emergency situation.

In accordance with another aspect of the invention, a composite wall 118 of the thermal insulator 110 of the electric vehicle battery pack 12, as shown in FIG. 5, in lieu of the silicone rubber layer 28, as discussed above for thermal insulator 10, can further include a second pressure sensitive adhesive layer 30 bonded to the second side 24 of the woven sheet of silica fabric 20 and further include a scrim reinforced, polyether ether ketone layer 32 bonded to the second pressure sensitive adhesive layer 30, such that the second pressure sensitive adhesive layer 30 is sandwiched between the second side 24 of the sheet of silica fabric 20 and the scrim reinforced, polyether ether ketone layer 32.

In accordance with another aspect of the invention, the electric vehicle battery pack can further include a release film 34 releasably fixed to the first pressure sensitive adhesive layer 26, with the release film 34 being configured to be removed to expose the underlying first pressure sensitive adhesive layer 26 for operable fixation to a surface of the respective cell 16 and housing 14.

In accordance with another aspect of the invention, the first pressure sensitive adhesive layer 26 and the second pressure sensitive adhesive layer 30 of the electric vehicle battery pack 12 can be provided as an acrylic pressure sensitive adhesive.

In accordance with another aspect of the invention, the composite wall 18, 118 of the electric vehicle battery pack 12 prevents flame propagation when exposed to 1000° C. for 10 minutes.

In accordance with another aspect of the invention, the composite wall 18, 118 of the electric vehicle battery pack 12 has an electrical insulation resistance of 4000 Mohm or greater before and after being exposed to 1000° C. for 10 minutes.

In accordance with another aspect of the invention, the composite wall 18, 118 of the electric vehicle battery pack 12 has a maximum thickness (t) of 5 mm.

In accordance with another aspect of the invention, the composite wall 18, 118 of the electric vehicle battery pack 12 has a maximum thickness (t) of 2 mm.

In accordance with another aspect of the invention, the composite wall 18, 118 of the electric vehicle battery pack 12 has a dielectric strength of 2 kV after being exposed to 1000° C. for 10 minutes.

Obviously, many modifications and variations of the present invention are possible in light of the above teachings. It is contemplated that all features of all claims and of all embodiments can be combined with each other, so long as such combinations would not contradict one another. It is, therefore, to be understood that within the scope of the appended claims, the invention may be practiced otherwise than as specifically described.

What is claimed is:

1. A flexible thermal insulator for an electric vehicle battery pack, comprising:
a composite wall including:
a sheet of flame-resistant material having opposite first and second sides;
a first pressure sensitive adhesive layer bonded to said first side of said sheet of flame-resistant material; and
one of a scrim reinforced, polyether ether ketone layer bonded to said second side said flame-resistant material, or a silicone rubber layer bonded to said second side of said flame-resistant material.

2. The flexible thermal insulator of claim 1, further including a second pressure sensitive adhesive layer bonded said scrim reinforced, polyether ether ketone layer.

3. The flexible thermal insulator of claim 2, further including a release film releasably fixed to said second pressure sensitive adhesive layer, said release film being configured to be removed to expose the underlying second pressure sensitive adhesive layer for fixation to a surface of the electric vehicle battery pack.

4. The flexible thermal insulator of claim 3, wherein said first pressure sensitive adhesive layer and said second pressure sensitive adhesive layer are an acrylic pressure sensitive adhesive.

5. The flexible thermal insulator of claim 1, wherein said wall prevents flame propagation when exposed to 1000° C. for 10 minutes.

6. The flexible thermal insulator of claim 1, wherein said wall has an electrical insulation resistance of 4000 Mohm or greater before and after being exposed to 1000° C. for 10 minutes.

7. The flexible thermal insulator of claim 1, wherein said wall has a maximum thickness of 5 mm.

8. The flexible thermal insulator of claim 7, wherein said wall has a maximum thickness of 2 mm.

9. The flexible thermal insulator of claim 1, wherein said wall has a dielectric strength of 2 kV after being exposed to 1000° C. for 10 minutes.

10. The flexible thermal insulator of claim 1, wherein said sheet of flame-resistant material is a woven sheet of silica multifilament yarns.

11. An electric vehicle battery pack, comprising:
a housing;
a plurality of cells bounded by said housing; and
a plurality of composite walls, each of said composite walls including:
a sheet of fire-resistant material having opposite first and second sides;
a first pressure sensitive adhesive layer bonded to said first side of said sheet of fire-resistant material; and
one of a scrim reinforced, polyether ether ketone layer bonded to said second side of said fire-resistant material, or a silicone rubber layer bonded to said second side of said fire-resistant material,
wherein said at least some of said composite walls separate adjacent ones of said cells from one another.

12. The electric vehicle battery pack of claim 11, wherein at least some of said composite walls include a second pressure sensitive adhesive layer bonded to said scrim reinforced, polyether ether ketone layer.

13. The electric vehicle battery pack of claim 12, further including a release film releasably fixed to said first pressure sensitive adhesive layer, said release film being configured to be removed to expose the underlying first pressure sensitive adhesive layer for operable fixation to a surface of said housing.

14. The electric vehicle battery pack of claim 13, wherein said first pressure sensitive adhesive layer and said second pressure sensitive adhesive layer are an acrylic pressure sensitive adhesive.

15. The electric vehicle battery pack of claim 11, wherein said composite wall prevents flame propagation when exposed to 1000° C. for 10 minutes.

16. The electric vehicle battery pack of claim 11, wherein said composite wall has an electrical insulation resistance of 4000 Mohm or greater before and after being exposed to 1000° C. for 10 minutes.

17. The electric vehicle battery pack of claim 16, wherein said composite wall has a maximum thickness of 2 mm.

18. The electric vehicle battery pack of claim 11, wherein said composite wall has a dielectric strength of 2 kV after being exposed to 1000° C. for 10 minutes.

19. The electric vehicle battery pack of claim 11, wherein said sheet of fire-resistant material is a silica fabric.

20. The electric vehicle battery pack of claim 19, wherein said sheet of silica fabric is a woven sheet, said woven sheet being woven from silica multifilament yarns.
